(19) United States
(12) Patent Application Publication
(10) Pub. No.: US 2012/0215580 A1
(43) Pub. Date: Aug. 23, 2012

(54) REASSIGNING WORKER PROFILES TO UNITS OF WORK

(76) Inventors: Roschelle E. Barney, Angier, NC (US); Christopher Schmitt, Clewiston, FL (US); Tony Doherty, Coventry (GB)

(21) Appl. No.: 13/031,476

(22) Filed: Feb. 21, 2011

(51) Int. Cl. G06Q 10/00

(52) U.S. Cl. 705/7.16

(57) ABSTRACT

Systems, methods, and computer program products are provided for reassigning worker profiles to units of work. For example, a scheduling system can reassign worker profiles to units of work and ensure that (a) workers/users are appropriately qualified to complete or perform units of work, (b) scheduling conflicts on a worker's/user's schedule are avoided, and (c) customizable rules and guidelines are followed.

### BACKGROUND

In various settings, workers/user may be assigned to units of work based on various factors, such as expected volumes of work. However, such factors can change on a day-to-day or hourly basis. Such changes may cause the need for changes with regard to the number of workers/users assigned to units of work. To compensate for the overage and/or shortage of workers/users, a need exists for a way to efficiently assign and/or reassign workers/users to units of work.

### BRIEF SUMMARY

In general, embodiments of the present invention provide systems, methods, apparatus, and computer program products for reassigning worker profiles to units of work.

In accordance with one aspect, a method for reassigning worker profiles to units of work is provided. In one embodiment, the method comprises (A) storing a plurality of worker profiles corresponding respectively to a plurality of workers; (B) receiving input selecting a new unit of work of a plurality of units of work for scheduling, wherein each unit of work comprises one or more work requirements selected from the group consisting of a primary skill, a start time, and an end time; and (C) after receiving input selecting the new unit of work of the plurality of units of work for scheduling, automatically identifying a reassignable worker profile of the plurality of worker profiles that can be assigned to the new unit of work, wherein (a) the reassignable worker profile is assigned to a previous unit of work, (b) the reassignable worker profile has been indicated as being available for reassignment from the previous unit of work, and (c) at least (1) the start time of the new unit of work is substantially similar to the start time of the previous unit of work or (2) the end time of the new unit of work is substantially similar to the end time of the previous unit of work.

In accordance with yet another aspect, a computer program product for reassigning worker profiles to units of work is provided. The computer program product may comprise at least one computer-readable storage medium having computer-readable program code portions stored therein, the computer-readable program code portions comprising executable portions configured to (A) store a plurality of worker profiles corresponding respectively to a plurality of workers; (B) receive input selecting a new unit of work of a plurality of units of work for scheduling, wherein each unit of work comprises one or more work requirements selected from the group consisting of a primary skill, a start time, and an end time; and (C) after receiving input selecting the new unit of work of the plurality of units of work for scheduling, automatically identify a reassignable worker profile of the plurality of worker profiles that can be assigned to the new unit of work, wherein (a) the reassignable worker profile is assigned to a previous unit of work, (b) the reassignable worker profile has been indicated as being available for reassignment from the previous unit of work, and (c) at least (1) the start time of the new unit of work is substantially similar to the start time of the previous unit of work or (2) the end time of the new unit of work is substantially similar to the end time of the previous unit of work.

In accordance with yet another aspect, an apparatus comprising at least one processor and at least one memory including computer program code is provided. In one embodiment, the at least one memory and the computer program code may be configured to, with the processor, cause the apparatus to at least (A) store a plurality of worker profiles corresponding respectively to a plurality of workers; (B) receive input selecting a new unit of work of a plurality of units of work for scheduling, wherein each unit of work comprises one or more work requirements selected from the group consisting of a primary skill, a start time, and an end time; and (C) after receiving input selecting the new unit of work of the plurality of units of work for scheduling, automatically identify a reassignable worker profile of the plurality of worker profiles that can be assigned to the new unit of work, wherein (a) the reassignable worker profile is assigned to a previous unit of work, (b) the reassignable worker profile has been indicated as being available for reassignment from the previous unit of work, and (c) at least (1) the start time of the new unit of work is substantially similar to the start time of the previous unit of work or (2) the end time of the new unit of work is substantially similar to the end time of the previous unit of work.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system according to various embodiments of the present invention.

FIG. 2 is an exemplary schematic diagram of a scheduling system according to one embodiment of the present invention.

FIGS. 3-5 are flowcharts illustrating operations and processes that can be used in accordance with various embodiments of the present invention.

FIGS. 6-30 are universal input and output produced by one embodiment of the invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

II. Exemplary System Architecture

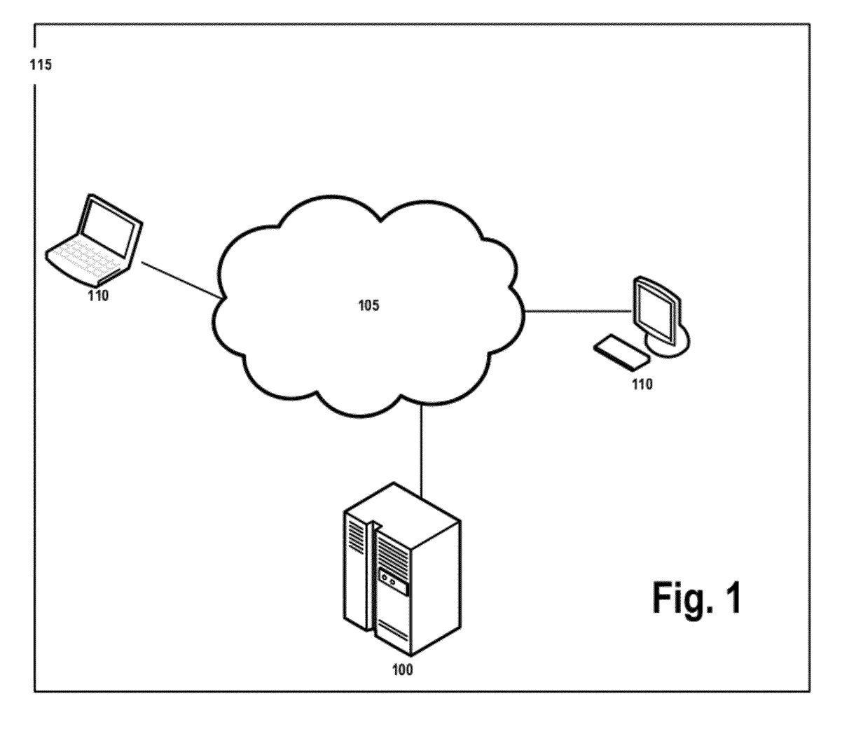

FIG. 1 provides an illustration of a system that can be used in conjunction with various embodiments of the present invention. As shown in FIG. 1, the system may include a scheduling system 100, a network 105, and one or more worker/user computing devices 110. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates the various system entities as separate, standalone entities, the various embodiments are not limited to this particular architecture.

1. Exemplary Scheduling System

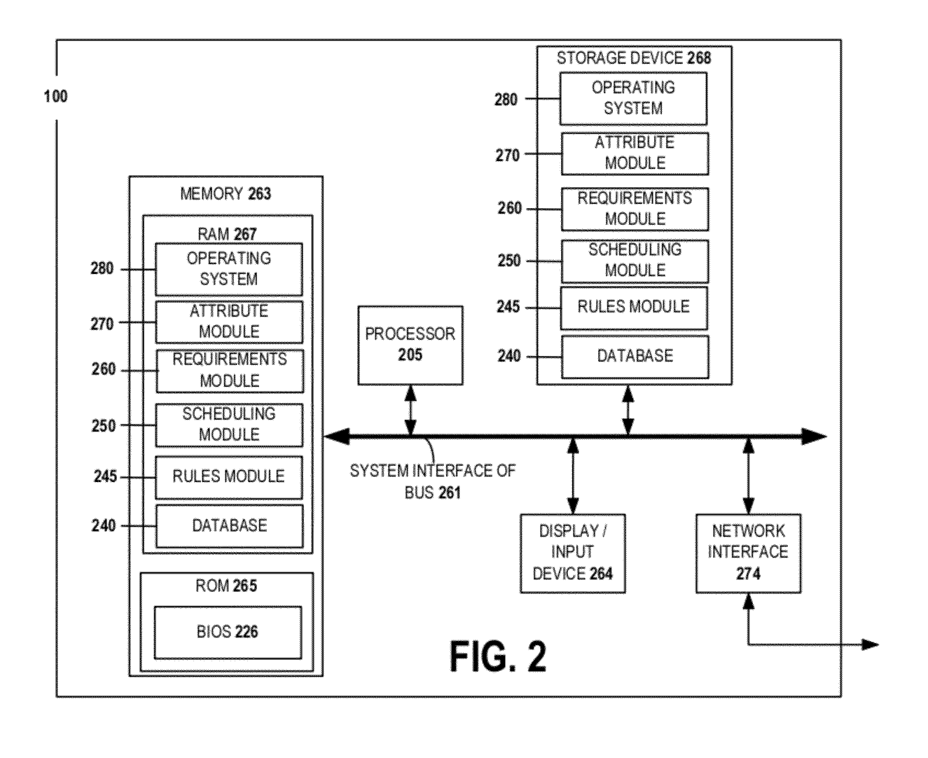

FIG. 2 provides a schematic of a scheduling system 100 according to one embodiment of the present invention. In general, the term “system” may refer to, for example, any computer, computing device, mobile phone, desktop, notebook or laptop, distributed system, server, blade, gateway, switch, processing device, or combination of processing devices adapted to perform the functions described herein. As will be understood from this figure, in one embodiment, the scheduling system 100 includes a processor 205 that communicates with other elements within the scheduling system 100 via a system interface or bus 261. The processor 205 may be embodied in a number of different ways. For example, the processor 205 may be embodied as a processing element, a coprocessor, a controller or various other processing devices including integrated circuits such as, for example, an application specific integrated circuit (ASIC), a field programmable gate array (FPGA), a hardware accelerator, or the like.

In an exemplary embodiment, the processor 205 may be configured to execute instructions stored in the device memory or otherwise accessible to the processor 205. As such, whether configured by hardware or software methods, or by a combination thereof, the processor 205 may represent an entity capable of performing operations according to embodiments of the present invention when configured accordingly. For example, as discussed in more detail below, the processor may be configured, among other things, to identify and reassign a reassignable worker profile from one unit of work to another unit of work. A display device/input device 264 for receiving and displaying data may also be included in the scheduling system 100. This display device/input device 264 may be, for example, a keyboard or pointing device that is used in combination with a monitor. The scheduling system 100 may further include transitory and non-transitory memory 263, which may include both random access memory (RAM) 267 and read only memory (ROM) 265. The scheduling system's ROM 265 may be used to store a basic input/output system (BIOS) 226 containing the basic routines that help to transfer information to the different elements within the scheduling system 100.

In addition, in one embodiment, the scheduling system 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, or the like. Additionally, each of these storage devices 268 may be connected to the system bus 261 by an appropriate interface.

Furthermore, a number of program modules may be stored by the various storage devices 268 and/or within RAM 267. Such program modules may include an operating system 280, an attribute module 270, a requirements module 260, a scheduling module 250, and a rules module 245. As discussed in more detail below, these modules may control certain aspects of the operation of the scheduling system 100 with the assistance of the processor 205 and operating system 280—although their functionality need not be modularized. In addition to the program modules, the scheduling system 100 may store or be in communication with one or more databases, such as database 240.

Also located within the scheduling system 100, in one embodiment, is a network interface 274 for interfacing with various computing entities. This communication may be via the same or different wired or wireless networks (or a combination of wired and wireless networks), as discussed above. For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the scheduling system 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the scheduling system's 100 components may be located remotely from other scheduling system 100 components. Furthermore, one or more of the components may be combined and additional components performing functions described herein may be included in the scheduling system 100.

2. Exemplary Computing Devices

The worker/user computing devices 110 may each include one or more components that are functionally similar to those of the scheduling system 100. For example, in one embodiment, each of the worker/user computing devices may include: (1) a processor that communicates with other elements via a system interface or bus; (2) a display device/input device; (3) memory including both ROM and RAM; (4) a storage device; and (5) a network interface. These architectures are provided for exemplary purposes only and are not limited to the various embodiments. The term “computing device” is used generically to refer to any computer, computing device, desktop, notebook or laptop, distributed system, server, gateway, switch, or other processing device adapted to perform the functions described herein.

III. Exemplary System Operation

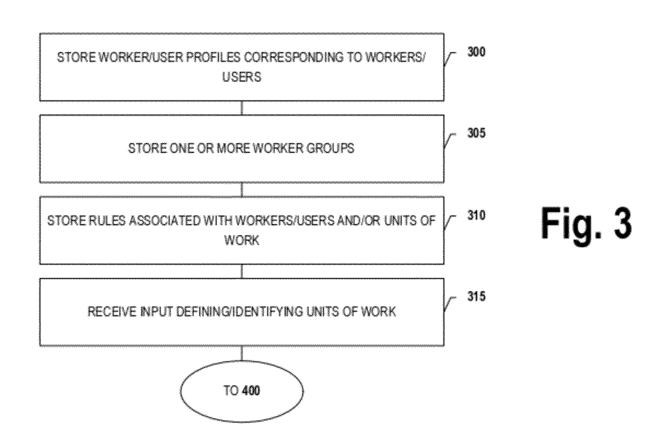

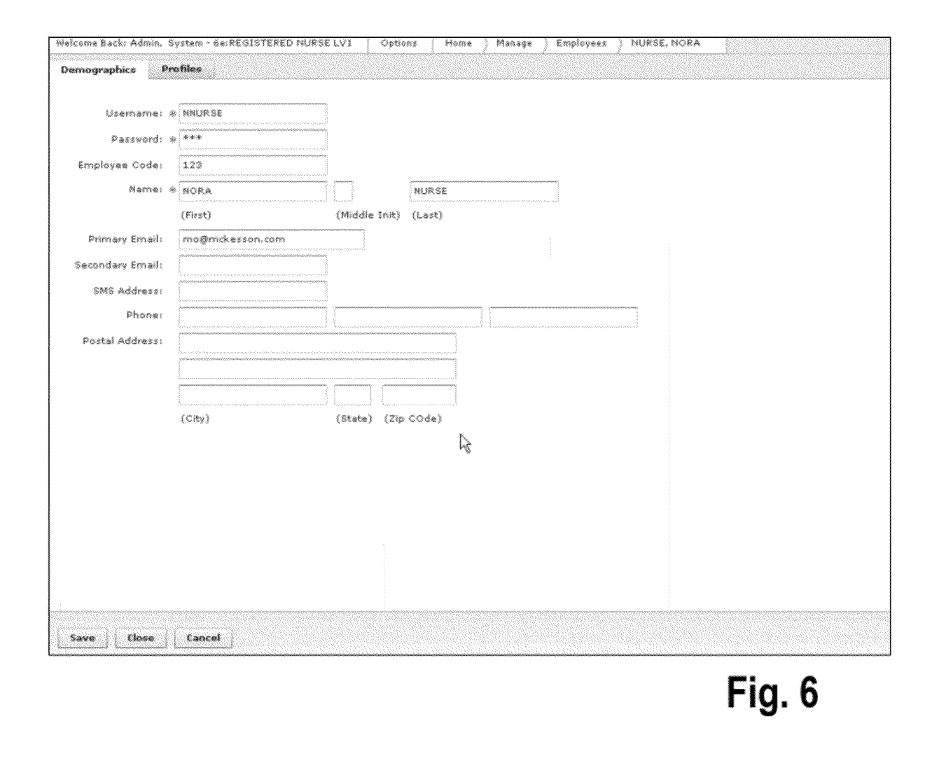

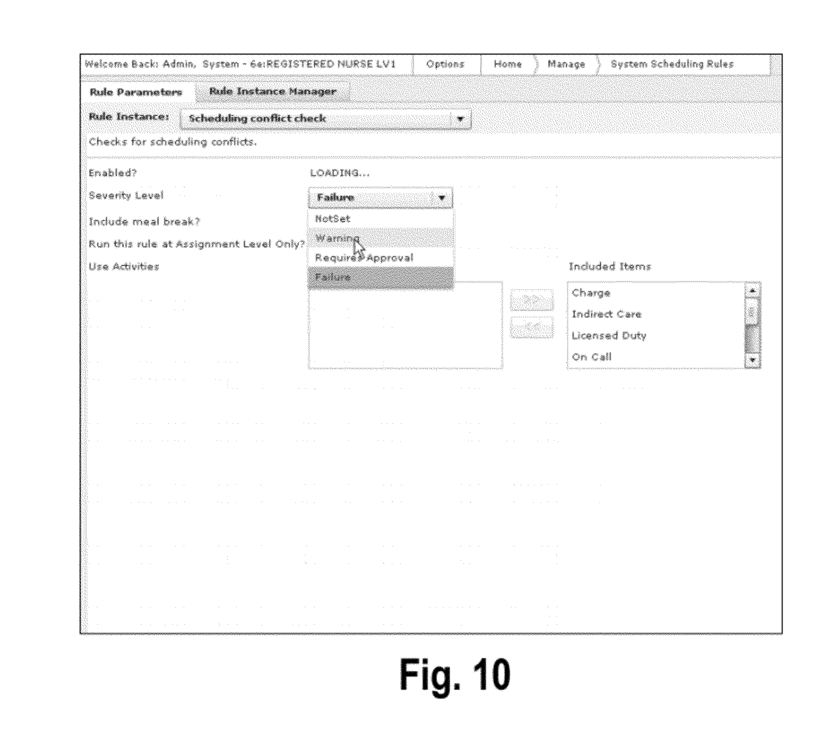

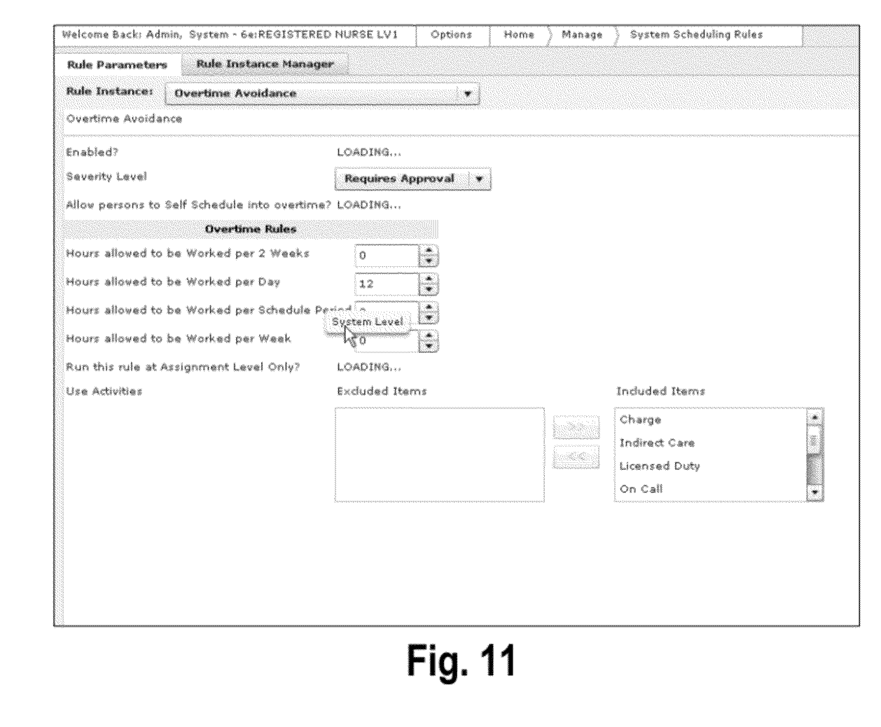

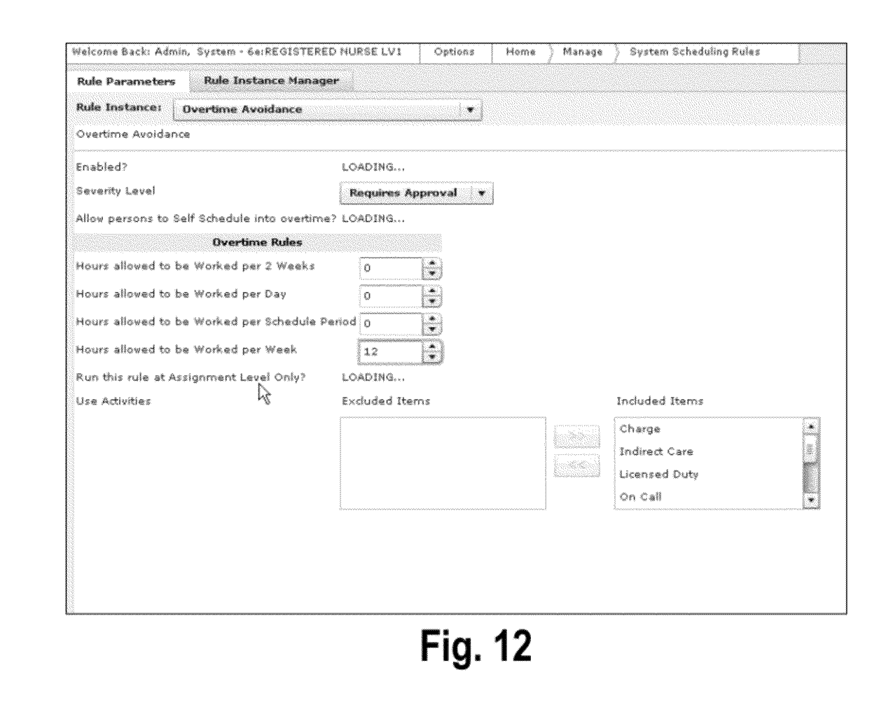

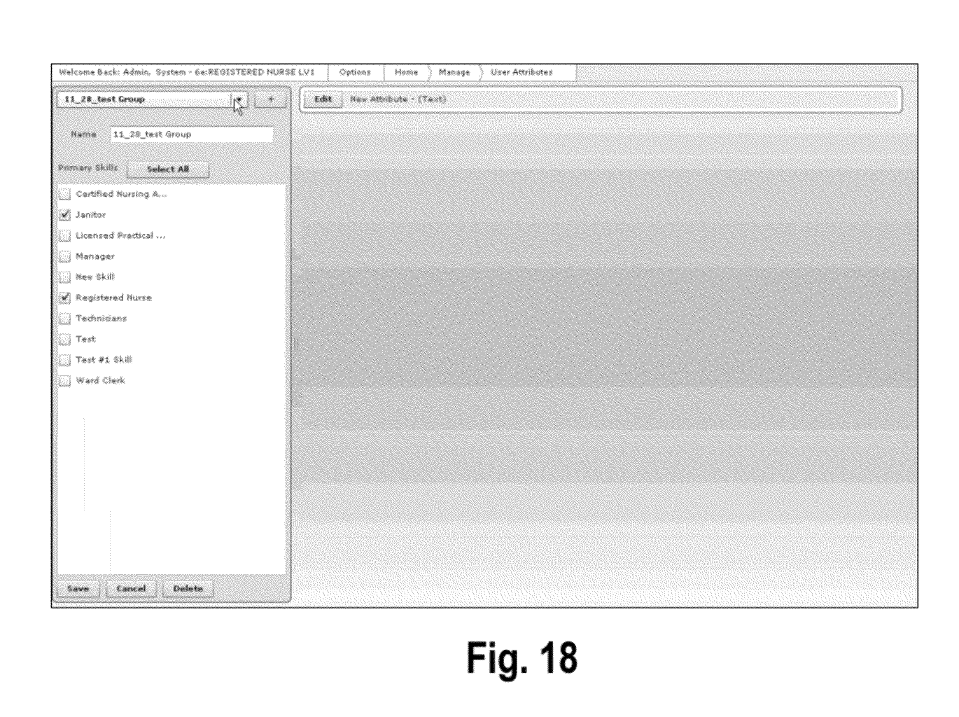

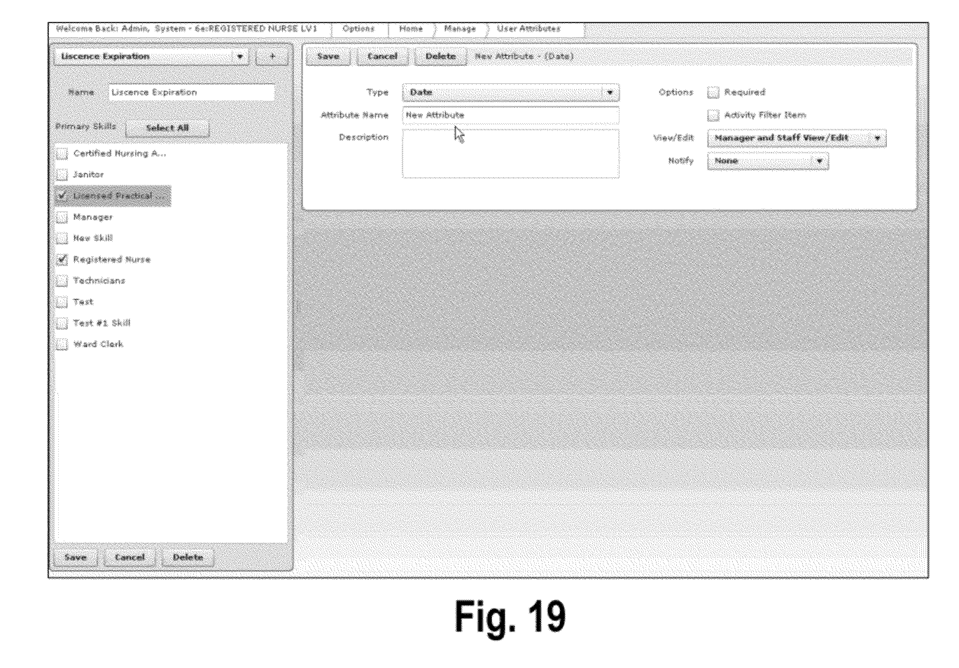

Reference will now be made to FIGS. 3-30. FIGS. 3-5 provide flowcharts illustrating operations that may be performed to schedule/assign units of work. FIGS. 6-30 show universal input and output produced by one embodiment of the invention.

1. Exemplary Worker/User Profiles

In one embodiment (Block 300 of FIG. 3), the scheduling system 100 may electronically store worker/user profiles that correspond to workers/users (e.g., people who can be assigned to units of work). The worker/user profiles may be used in scheduling workers/users to perform units of work. For example, a unit of work may be a shift at a hospital, a task to be performed in a health care facility, a repair at an automotive repair shop, attendance at a conference as a representative of a corporation, the delivery of flower arrangements for a florist, and/or a variety of other tasks/jobs.

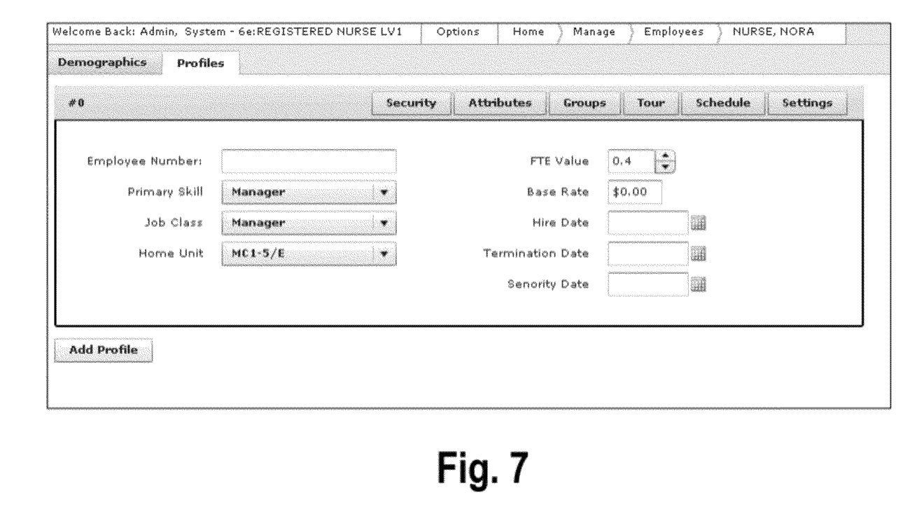

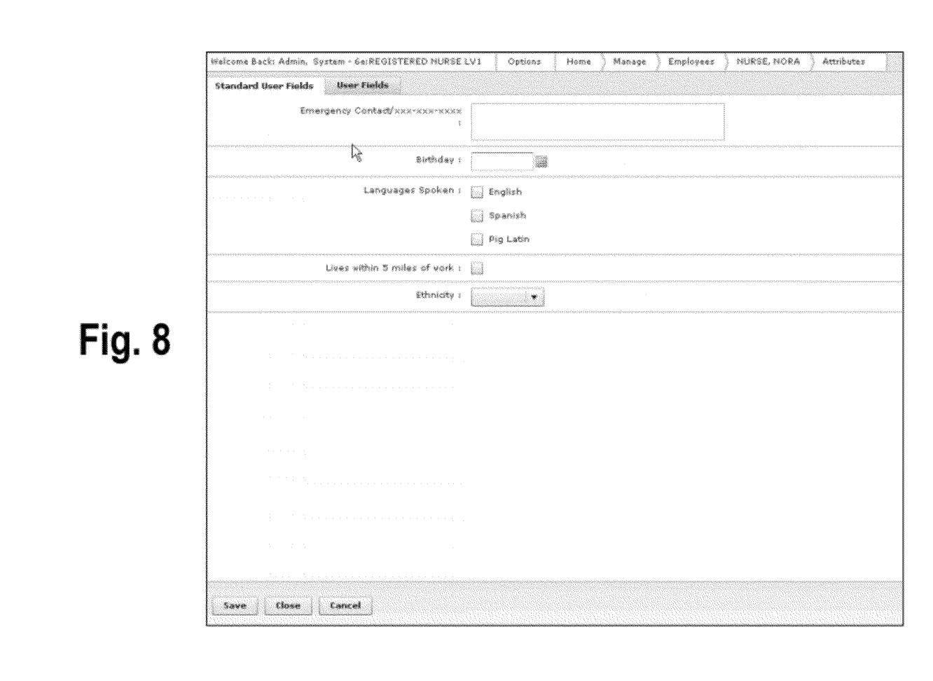

In one embodiment, to assist in scheduling workers/users to perform units of work, the worker/user profiles can be used to store attributes associated with the corresponding workers/users. The worker/user profiles can be created, edited, and customized based on the nature of the associated units of work (e.g., via the attribute module 270). For example, as shown in FIG. 6, a worker/user profile may include a worker's/user's username to access the scheduling system 100, password to access the scheduling system 100, employee identification number, name, email addresses, short message service (SMS) addresses, phone numbers, and/or residential address. In addition to biographical information, as shown in FIGS. 7-8, a worker/user profile may also comprise the worker's/user's primary skill (e.g., manager, nurse, doctor, or mechanic), work/job class (e.g., a nurse may be a neonatal nurse, a nurse anesthetist, or an occupational health nurse), home team of workers/users (e.g., the worker's/user's department), full-time equivalent value, base rate of pay, hire date, termination date, and/or seniority date. Similarly, a worker/user profile may also comprise the worker's/user's emergency contact information, birthday, languages spoken, driving distance to work, and/or ethnicity. Although not shown, other information could also be stored within a worker/user profile, such as the worker's/user's certifications or licenses, schedule preferences, religious holidays observed, allergies, and/or physical limitations. Such information can be input (e.g., via worker/user computing devices 110) using radio buttons, drop down boxes, textual input, voice recognition software, and/or a variety of other approaches and techniques.

In one embodiment, worker/user profiles may also define access rights/permissions for the scheduling system 100. For example, a worker/user profile may be associated with administrator rights/permissions, manager rights/permissions, coordinator rights/permissions, and/or worker/user rights/permissions. Administrator rights/permissions may provide the corresponding worker(s)/user(s) with administrator level rights/permissions, such as the ability to create worker/user profiles, establish rights/permissions for managers and coordinators, create rules for a facility (or globally for an organization), and/or the like. Similarly, manager rights/permissions may provide the corresponding worker(s)/user(s) with manager level rights, such as the ability to add workers/users to certain teams of workers/users (e.g., nurses assigned to a neonatal unit at a hospital), assign workers/users on multiple teams of workers/users to units of work, and edit worker/user profiles for certain worker/user groups. Coordinator rights/permissions may provide the corresponding worker(s)/user(s) with coordinator level rights, such as the ability to add workers/users to certain home teams of workers/users, assign workers/users on multiple home teams of workers/users to units of work, and edit worker/user profiles for certain worker/user groups. And finally, worker/user rights/permissions may provide the corresponding worker(s)/user(s) with worker/user level rights, such as the ability to view the worker's/user's schedule and update the worker's/user's schedule preferences.

In one embodiment, a worker/user may be associated with more than one worker/user profile. Similarly, a worker/user profile may comprise sub-profiles. For example, a worker/user with multiple primary skills (e.g., a worker/user who is both a paramedic and an emergency room attendant) may have multiple worker/user profiles or a single worker/user profile with multiple sub-profiles to allow the worker/user to be assigned to units of work that require different primary skills.

In one embodiment, each worker/user profile can also be associated with or assigned to one or more worker/user groups (Block 305 of FIG. 3), which can be stored by the scheduling system 100. The worker/user groups can be used to, for example, group workers/users who have similar primary skills, work at the same facility, work in the same department within a facility, work on the same team of workers/users, hold certain certifications, and/or report to a common supervisor. For example, a worker/user group may comprise the nurses in the neonatal unit at Good Health Hospital or the automotive service excellence certified mechanics at the Friendly Toyota Dealership. As will be recognized, a variety of approaches and techniques may be used to adapt to various needs and circumstances.

2. Exemplary Rules

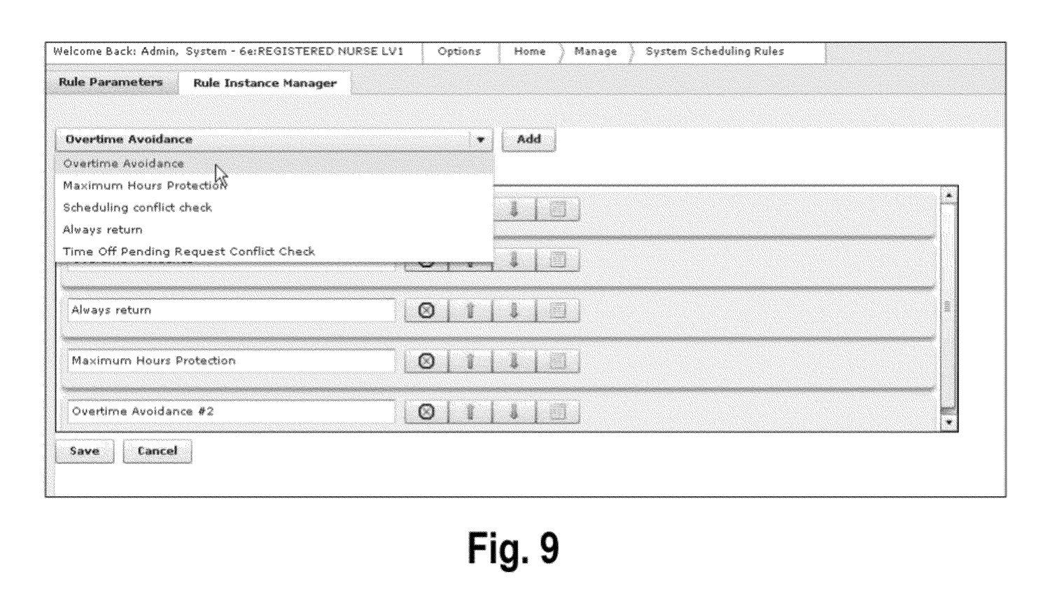

In one embodiment, as indicated in Block 310 of FIG. 3, the scheduling system 100 can store rules for use in assigning worker/user profiles to units of work. As shown in FIGS. 9-12, the rules can be created, defined, and edited by the scheduling system 100 via, for example, workers/users operating worker/user computing devices 110. In one embodiment, the scheduling system 100 (e.g., via the rules module 245) can store rules that must be complied with for a worker/user profile to be assigned to a unit of work. For example, a rule may be defined that does not allow for a worker/user profile to be assigned to more than one unit of work at any given time, e.g., thereby avoiding scheduling conflicts. In one embodiment, the scheduling system 100 may also store rules that require a warning be displayed to the scheduler (e.g., via a worker/user computing device 110) before assigning a worker/user profile to a unit of work. For instance, a rule may be defined that requires a warning be displayed to the scheduler before assigning a worker/user to work more than 12 consecutive hours. In one embodiment, the scheduling system 100 may also store rules that require authorization before assigning a worker/user profile to a unit of work. For example, a rule may be defined that requires authorization to assign a worker/user profile to a unit of work that would result in overtime for the worker/user.

In various embodiments, such rules may be used to provide global, regional, local, facility-based, group-based, or profile-based guidelines and restrictions for assigning worker/user profiles to units of work. For example, a worker/user (e.g., via a worker/user computing device 110) with administrator rights/permissions may create, edit, and store rules that apply globally to an organization regardless of the location of facilities or nature of the units of work, such as no overtime for any workers/users during the month of July. Similarly, rules may be defined to only apply to a particular facility, such as no worker in the Good Health Hospital can be assigned to work more than 18 hours consecutively. Further, rules may be defined to only apply to a particular team of workers/users, such as no nurse anesthetists can work more than 16 hours in a 24-hour period. Thus, the rules can be implemented, for example, to avoid or limit overtime, provide maximum hours policies, avoid scheduling conflicts, and/or comply with time-off requests. As will be recognized, though, the rules may be customized to adapt to the needs of an organization, facility, team, workers/users, units of work, and/or the like.

3. Exemplary Units of Work

In one embodiment, the scheduling system 100 can receive input (e.g., via the requirements module 260) defining one or more units of work (Block 315 of FIG. 3). As indicated previously, a unit of work may be, for example, a shift at a hospital, a repair at an automotive repair shop, attendance at a conference as a representative of a corporation, delivery of flower arrangements for a florist, and/or a variety of other tasks/jobs.

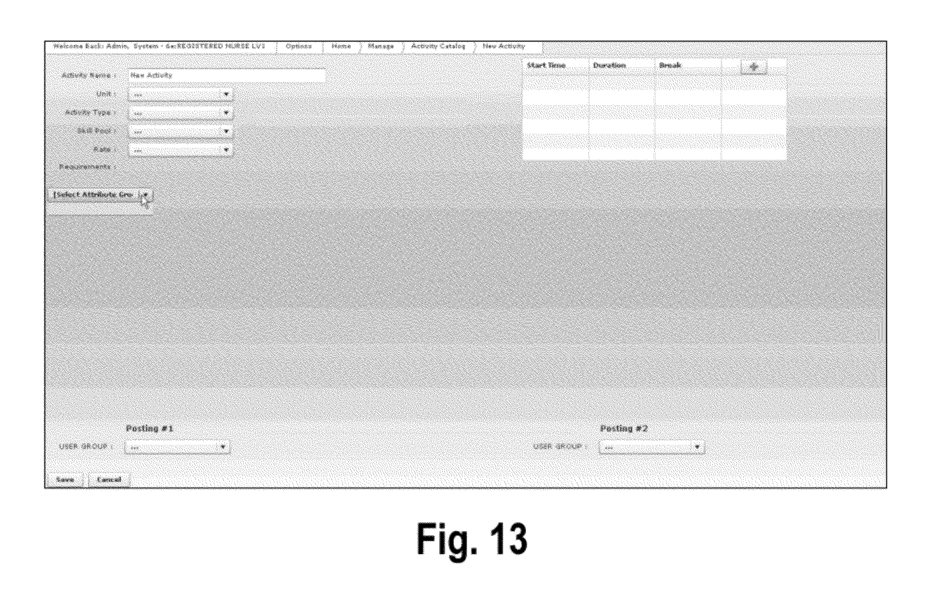

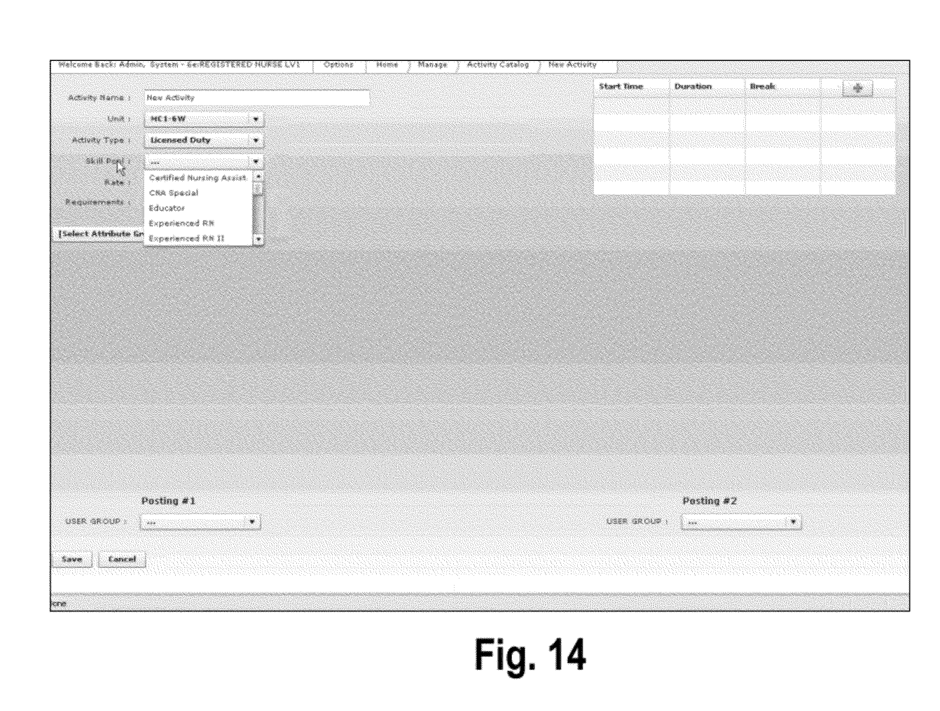

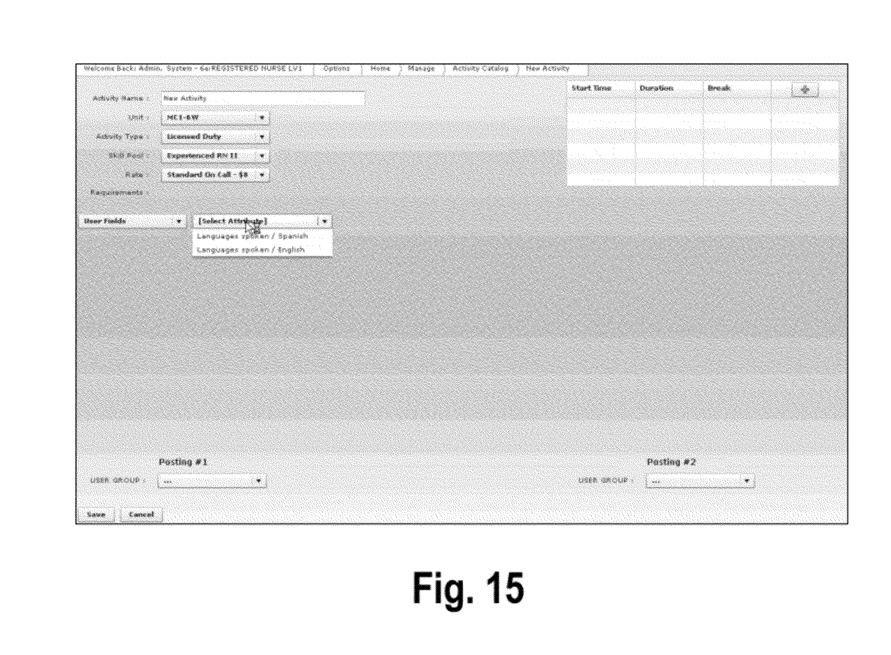

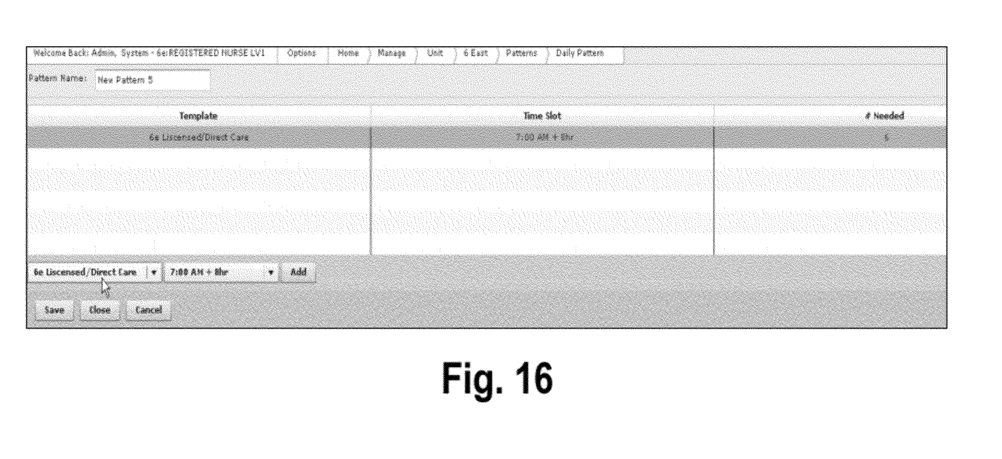

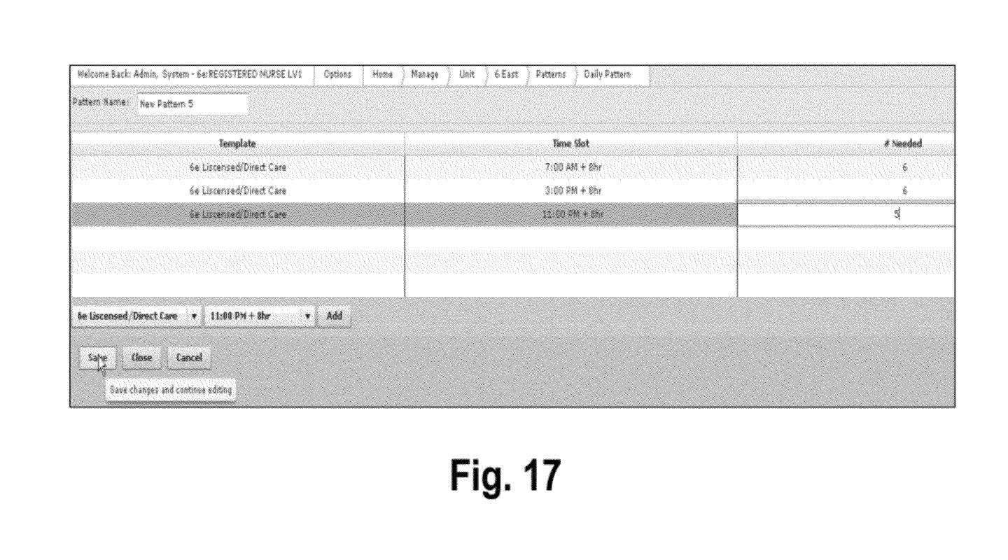

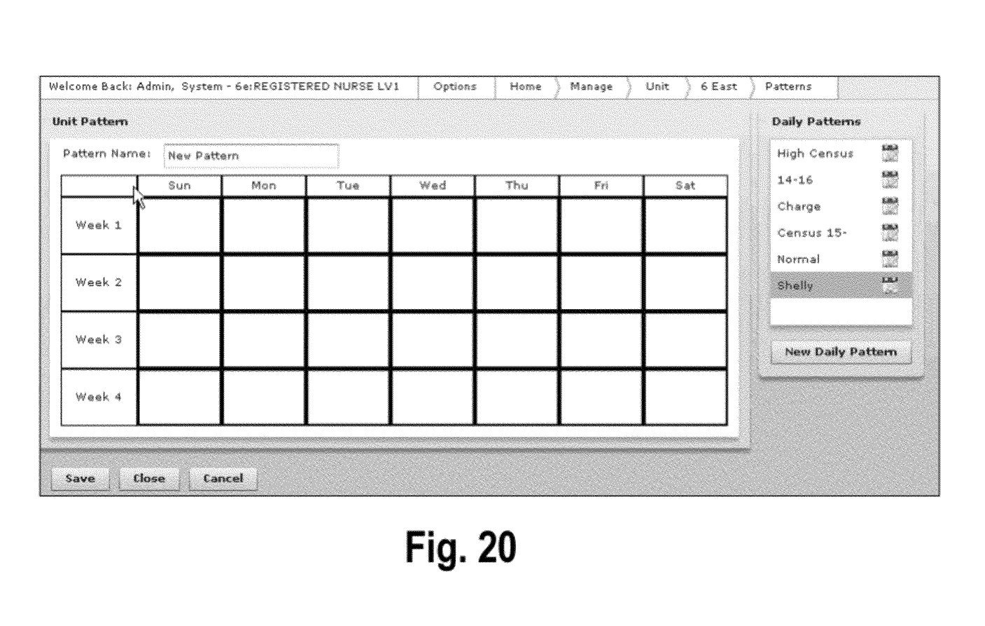

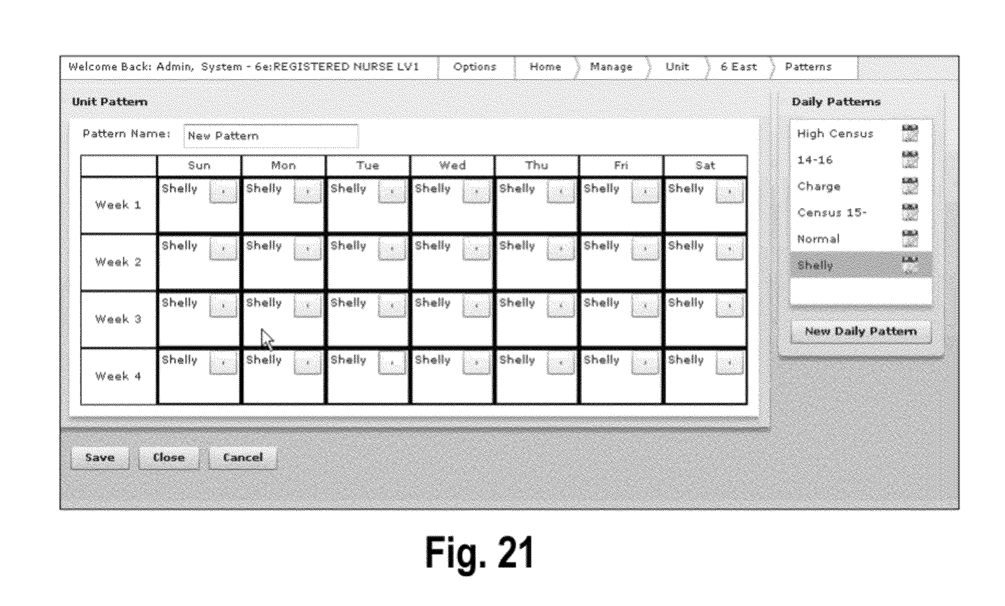

In one embodiment, each unit of work comprises work requirements associated with the unit of work. In a health care setting, units of work may be created/defined based on patient census data, the expected number of visitors to a health care facility, and/or the expected number of admissions and discharges. Thus, for example, as shown in FIG. 13, the work requirements for a unit of work may identify, for example, the name of the unit of work, location of the unit of work, primary skill required, work/job class, date, start time, end time, break times, base rate of pay, and/or the like. By way of example, as shown in FIG. 14, the primary skill defined by the work requirements may require that the primary skill of the worker/user be, for example, a certified nursing assistant, a CNA Special, Educator, Experienced RN, or an Experienced RN II. Furthermore, additional work requirements can be added to customize the work requirements for the unit of work. For example, as shown in FIGS. 15 and 18-19, the work requirements can be customized to require that the worker/user speak a specific language, be assigned to a particular team of workers/users, have a certain license or certification on the date of the unit of work, live within a certain distance from work (e.g., for emergency responses), and/or a variety of other options. Similarly, as shown in FIGS. 16 and 17, the work requirements may indicate the number of workers/users needed to be assigned to a particular unit of work, e.g., 6 licensed, direct care nurses need to be assigned to the 7:00 am shift that lasts 8 hours. Moreover, as shown in FIGS. 20 and 21, a unit of work can be named (e.g., via worker/user computing devices 110) and stored by the scheduling system 100 for duplication of the unit of work that, for example, can be applied to other days, weeks, months, and/or scheduling periods.

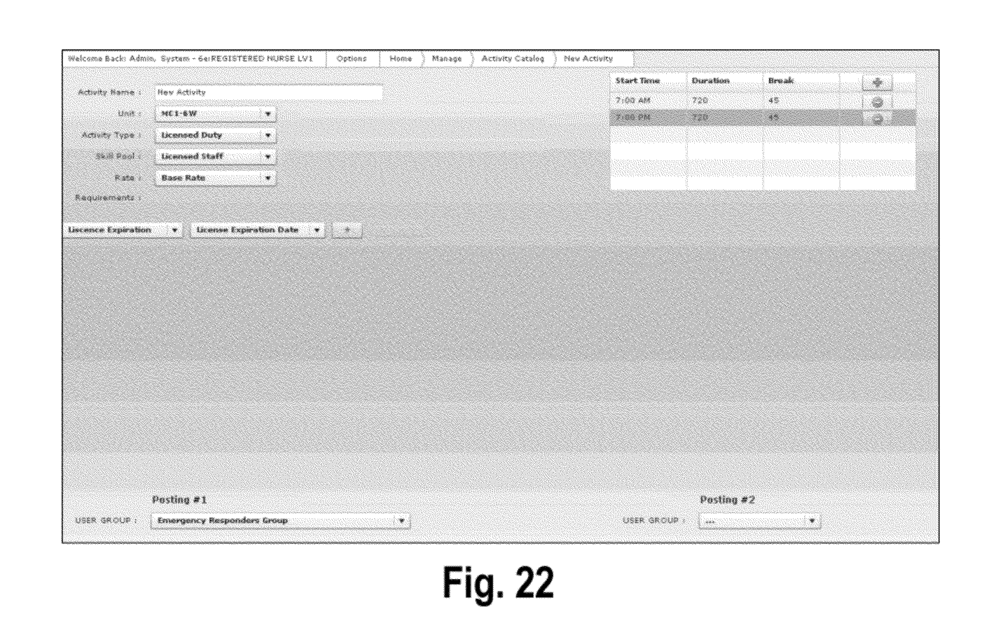

In one embodiment, once a unit of work has been defined, the unit of work can be viewed, posted, and/or assigned. For example, the scheduling system 100 can receive input (e.g., via a worker/user computing device 110) requesting that a unit of work be posted (e.g., FIG. 22). In response to (e.g., after) receiving this input, the scheduling system 100 can generate a notification that the unit of work is available for assignment and/or make the unit of work visible (e.g., searchable, viewable, and, assignable via a worker/user computing device 110) to certain worker/user profiles, such as those with coordinator rights/permissions and higher.

4. Exemplary Assignment of Workers/Users and Units of Work

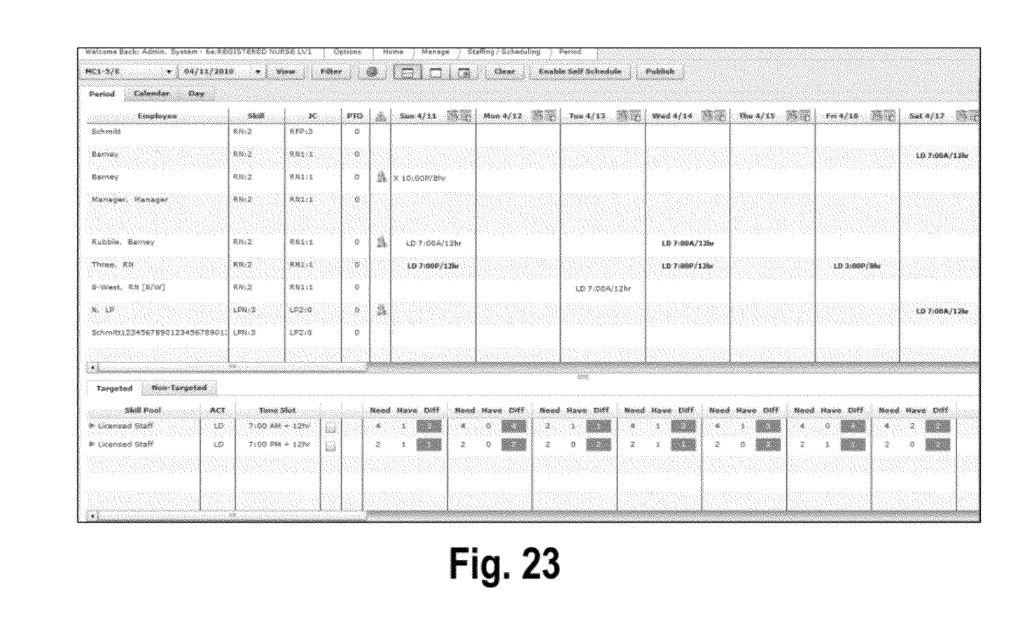

In one embodiment, a worker/user with the appropriate access rights/permissions can access the scheduling system 100 (e.g., via a worker/user computing device 110) to assign units of work. To assign units of work, the scheduling system 100 can receive input (e.g., from a worker/user operating a worker/user computing device 110) requesting the execution of an automated scheduling operation. The automated scheduling operation may be, for example, the automatic identification (a) of units of work to which worker/user profiles can be assigned or (b) of worker/user profiles that can be assigned to a unit of work (e.g., via the scheduling module 250). In other words, the automated scheduling operation may be a bidirectional operation (see, e.g., FIG. 23), as discussed below.

i. Exemplary Automated Unit of Work Identification

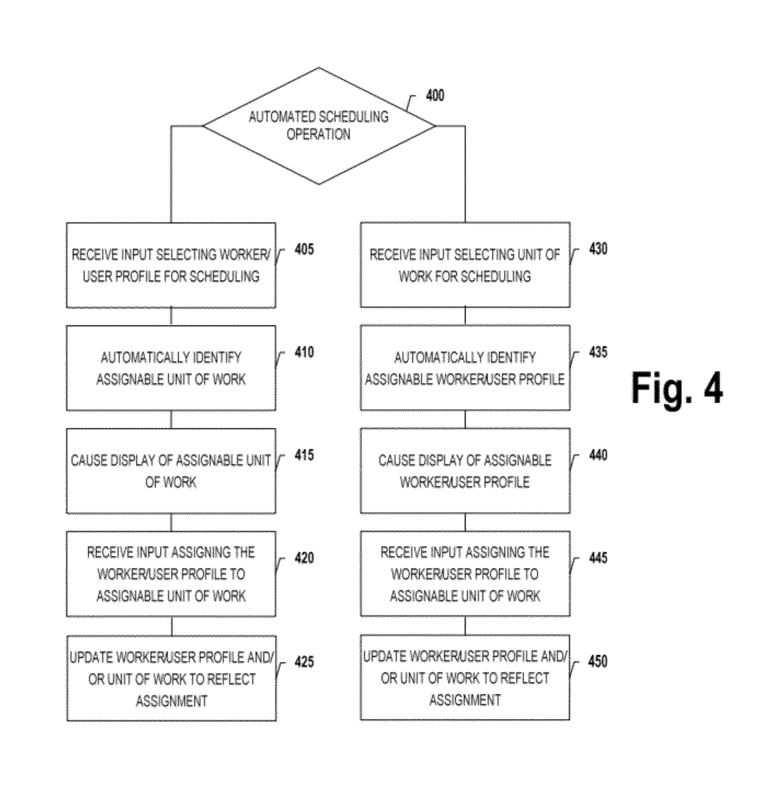

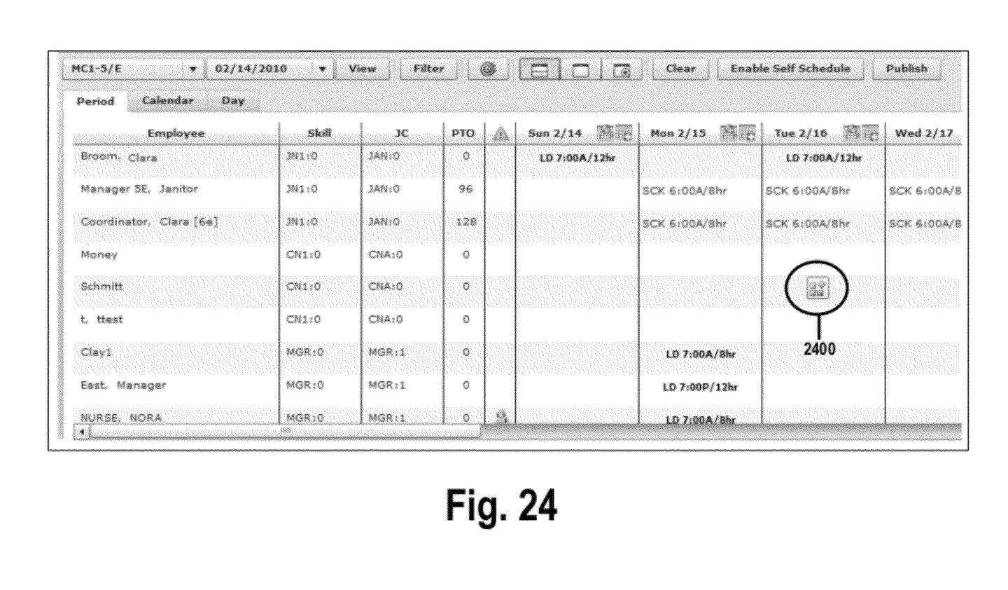

In one embodiment, the scheduling system 100 can perform automated scheduling operations (Block 400 of FIG. 4). For example, the automated scheduling operation may be the automatic identification of units of work to which a worker/user profile can be assigned (Block 405 of FIG. 4). In such an embodiment, the scheduling system 100 can automatically identify one or more assignable units of work for a worker/user profile (e.g., units of work to which the worker/user profile can be assigned). For instance, a worker/user with the appropriate access rights/permissions can log onto the scheduling system 100 to schedule “Schmitt” for work on February 16. In this example, the worker/user could click on or select an icon/glyph (such as icon 2400 shown in FIG. 24) corresponding to Schmitt and February 16. In response to (e.g., after) receiving this input, the scheduling system 100 can automatically identify assignable units of work for Schmitt for February 16 (e.g., units of work to which Schmitt could be assigned to perform on February 16).

In one embodiment, to perform such an operation, as indicated in Block 410 of FIG. 4, the scheduling system 100 can automatically identify the units of work for which the worker/user can make assignments (e.g., worker/user groups associated with the worker/user profile), to which Schmitt is qualified to be assigned, and/or that comply with any corresponding rules. Continuing with the above example, Schmitt's attributes in her worker/user profile may indicate that she is an RN with a work/job class of “RN1” and speaks Spanish. Accordingly, the scheduling system 100 can evaluate the units of work for February 16 and eliminate (e.g., filter) any units of work for which Schmitt cannot be assigned. As will be recognized, a variety of rules may also be considered. At this point, the resultant units of work are the “assignable units of work.”

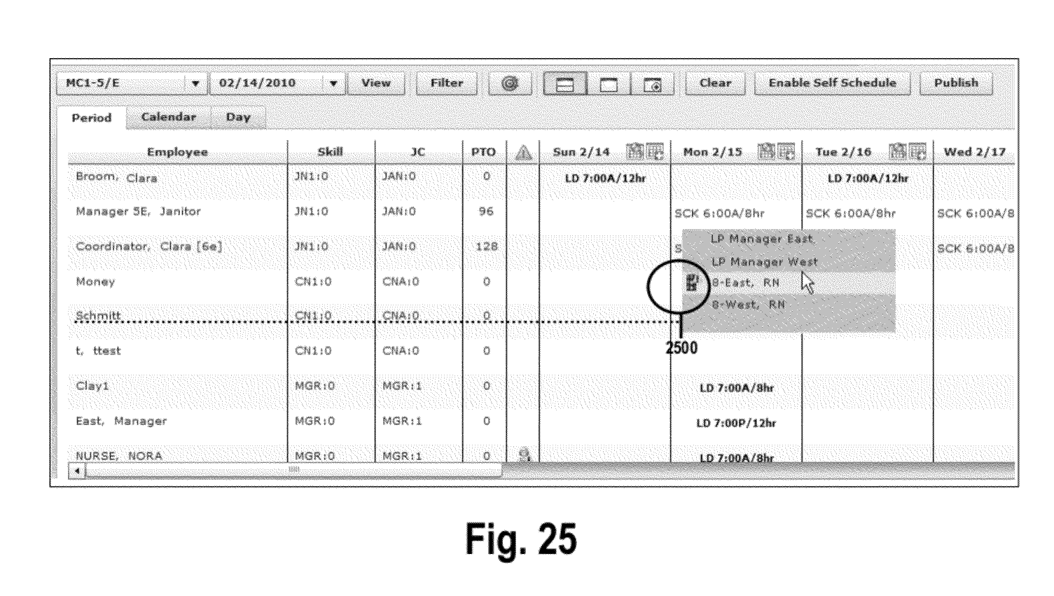

Continuing with the above example, in one embodiment, the scheduling system 100 can then cause display of the assignable units of work (Block 415 of FIG. 4). For example, as shown in FIG. 25, the assignable units of work for Schmitt on February 16 may be the (1) LP Manager East; (2) LP Manager West; (3) 8-East, RN; and (4) 8-West, RN units of work. In addition to or alternatively, the scheduling system 100 may cause display of the assignable units of work with different information (not shown), such as (1) a 7:00 am 12-hour shift that could be filled by an RN or LPN of any work/job class, (2) a 3:00 pm 8-hour shift to work as the charge nurse that could only be filled by an RN with one of three work/job classes, or (3) a 7:00 am 8-hour shift to work productive duty that has to be filled by a Spanish-speaking RN only of any work/job class.

In addition to causing display of the assignable units of work, the scheduling system 100 can cause display of other information as well, e.g., warnings and required authorizations. For example, as seen in FIG. 25, the icon/glyph (icon 2500) next to the “8-East, RN” unit of work may indicate that authorization to infract a rule is required to assign the work unit to Schmitt. The scheduling system 100 can also cause display of additional information regarding an assignable unit of work, such as the base rate of pay for the unit of work or the type of authorization that would be required to assign the unit of work. As will be recognized, there are a variety of approaches and techniques that can be used to cause display of such information to the worker/user.

In one embodiment, as indicated in Block 420 of FIG. 4, after causing display of the assignable units of work, the scheduling system 100 can receive input assigning the worker/user profile to an assignable unit of work (e.g., via a worker/user operating a worker/user computing device 110). If authorization is not required to assign the assignable unit of work to the worker/user profile, the scheduling system 100 can update the worker/user profile to reflect the assignment of the assignable unit of work (e.g., set the worker's/user's “availability flag” to “false” for the assigned time period) and indicate that the unit of work has been assigned (Block 425 of FIG. 4). By setting the worker's/user's availability flag to false for the assigned time period, the worker/user profile will not be shown as assignable to other units of work for the assigned time period. If authorization is required to assign the assignable unit of work to the worker/user profile, the scheduling system 100 can automatically generate a request to authorize or deny the assignment of the assignable unit of work. In response to (e.g., after) receiving an authorization from the appropriate party, the scheduling system 100 can update the worker/user profile to reflect the assignment of the assignable unit of work and indicate that the unit of work has been assigned (Block 425 of FIG. 4). Otherwise, the scheduling system 100 does not assign the unit of work to the worker/user profile, such as in the event of a denial of the request for authorization.

ii. Exemplary Automated Worker/User Profile Identification

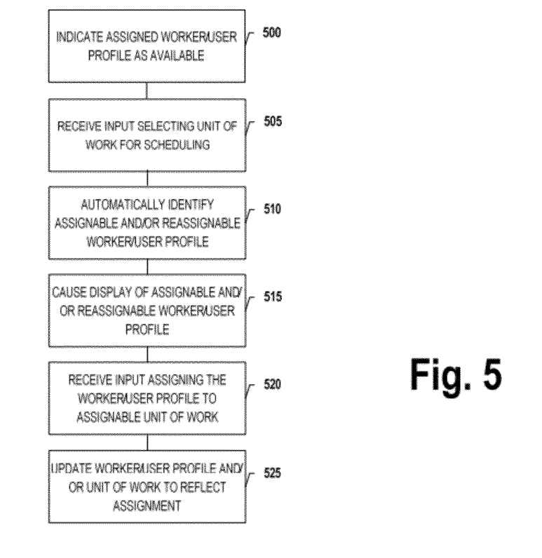

In one embodiment, as indicated in FIGS. 4 and 5, the scheduling system 100 can perform other automated scheduling operations (Blocks 400 of FIG. 4). For example, the scheduling system 100 can automatically identify one or more assignable worker/user profiles that can be assigned to a unit of work. Thus, a worker/user with the appropriate rights/permissions can access the scheduling system 100 to assign workers/users (e.g., via their respective worker/user profiles) to units of work. To do so, a worker/user may click on or select information corresponding to unit of work to assign (Block 430 of FIG. 4). In response to (e.g., after) receiving such input, the scheduling system 100 can automatically identify worker/user profiles that can be assigned to perform the unit of work.

In one embodiment, to perform this operation, as indicated in Block 435 of FIG. 4, the scheduling system 100 can automatically identify worker/user profiles for which the worker/user can make assignments (e.g., worker/user groups associated with the worker/user profile), that are qualified to be assigned to the unit of work, and that comply with any corresponding rules. For example, the work requirements of the unit of work may indicate that the worker/user (a) be an RN with a work/job class of “RN1” and (b) speak Spanish. Accordingly, the scheduling system 100 can evaluate the worker/user profiles and eliminate (e.g., filter) any profiles of workers/users who (a) are not for RNs with a work/job class of RNI, (b) do not speak Spanish, and (c) who are not available to work in the corresponding time period. As will be recognized, a variety of other work requirements and rules may also be considered. At this point, the resultant worker/user profiles are the “assignable worker/user profiles.”

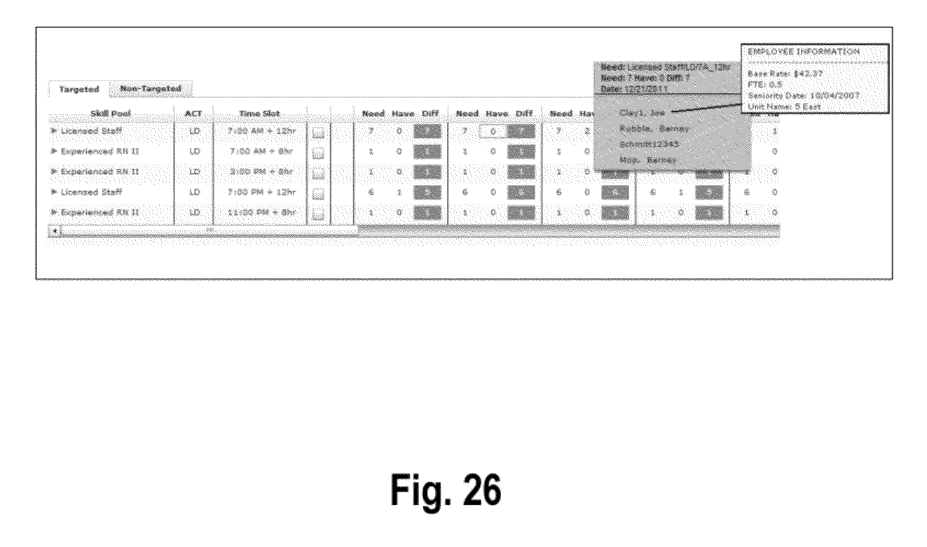

In one embodiment, the scheduling system 100 can then cause display of the assignable worker/user profiles (Block 440 of FIG. 4). For example, as shown in FIG. 26, the assignable worker/user profiles that are displayed may be (a) Joe Clayl, (b) Barney Rubble, (c) Schmitt12345, and (d) Barney Mop. In addition to causing display of the assignable worker/user profiles, the scheduling system 100 can cause display of other information as well. For instance, when a worker/user operating a worker/user computing device 110 hovers or mouses over a name of an assignable worker/user profile, the scheduling system 100 may cause display of information, such as the worker's/user's base rate of pay or FTE value and any warnings and required authorizations.

In one embodiment, as indicated in Block 445 of FIG. 4, after causing display of the assignable worker/user profiles, the scheduling system 100 can receive input assigning an assignable worker/user profile to the unit of work (e.g., via a worker/user, operating a worker/user computing device 110). If authorization is not required to assign the assignable worker/user profile to the unit of work, the scheduling system 100 can update the worker/user profile to reflect the assignment of the assignable worker/user profile to the unit of work (e.g., set the worker's/user's availability flag to false for the assigned time period) and indicate that the unit of work has been assigned (Block 450 of FIG. 4). By setting the worker's/user's availability flag to false for the assigned time period, the worker/user profile will not be shown as assignable to other units of work for the assigned time period. If authorization is required, the scheduling system 100 can automatically generate a request to authorize or deny the assignment of the assignable worker/user profile. In response to (e.g., after) receiving an authorization from the appropriate party, the scheduling system 100 can update the assignable worker/user profile to reflect the assignment of the unit of work and indicate that the unit of work has been assigned (Block 450 of FIG. 4). Otherwise, the scheduling system 100 does not assign the unit of work to the worker/user profile, such as in the event of a denial of the request for authorization.

5. Exemplary Reassignment of Workers/Users and Units of Work

As indicated, worker/user profiles may be assigned to units of work based on various factors, such as expected volumes of work. For instance, in a health care setting, workers/users may be assigned to units of work based on patient census data, the expected number of visitors to a health care facility, and/or the expected number of admissions and discharges. However, such factors can change on a day-to-day basis causing the need for changes with regard to the number of workers/users assigned to units of work. For example, a neonatal health care unit may anticipate a need of 6 licensed, direct care nurses for the 8-hour 7:00 am shift on Dec. 12, 2012. However, as December 12th approaches (or on December 12th), the actual need for the health care unit may be greater or less than expected. For instance, in overage situations of too many workers/users, some of the 6 workers/users (e.g., licensed, direct care nurses) assigned to perform the 8-hour 7:00 am shift on December 12th may be better used to perform other units of work. In other words, for example, some of the 6 assigned workers/users may be used to work the shift for another unit in the health care facility. This may be referred to as “floating out.” In another example, 8 workers/users (e.g., licensed, direct care nurses) may actually be needed to cover the 8-hour 7:00 am shift on December 12th in the neonatal health care unit—2 more than initially expected. To compensate for the shortage of workers/users, additional workers/users can be assigned or reassigned to the neonatal unit for this shift, e.g., workers may “float in.” In various embodiments, such assignments and reassignments can be important from a quality of work and cost perspective. For instance, in a health care setting, there may be established guidelines that there be a certain number of hours of licensed care per patient day provided for certain types of patients (e.g., on the neonatal unit, each infant should receive a minimum of 8 hours of care per day from licensed staff). Thus, for example, if the neonatal unit were understaffed based on their census, they could be in a position of violating these guidelines.

i. Exemplary Indicating Assigned Workers/Users as Available for Reassignment

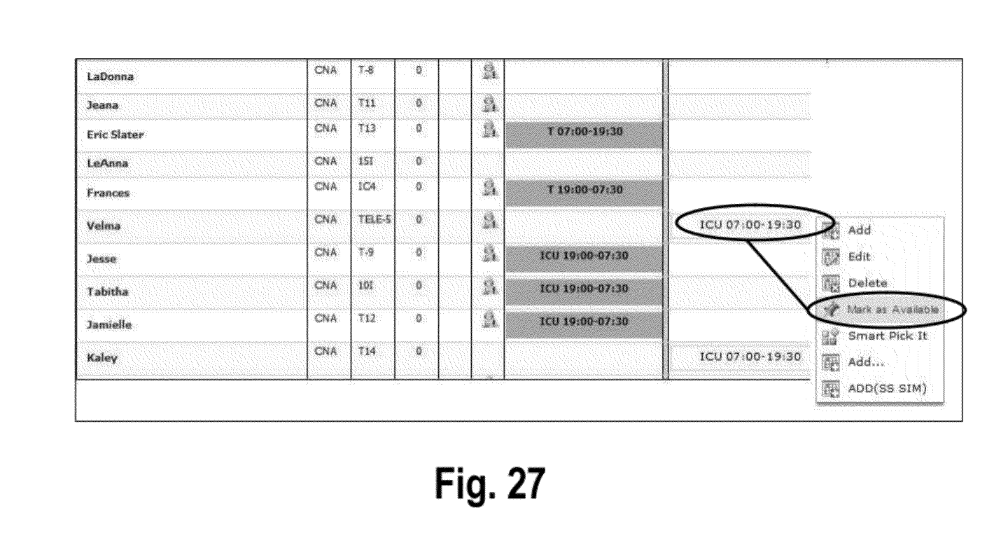

As indicated previously, once a worker/user profile is assigned to a unit of work, the scheduling system 100 can update the worker/user profile to reflect the assignment of the unit of work. This may include setting the worker's/user's availability flag to false for the time period corresponding to the unit of work. Thus, in such instances, the assigned worker/user profile will not be shown as assignable for units of work for the same time period. However, as indicated in Block 500 of FIG. 5, if a worker/user is no longer needed to perform an assigned unit of work, the worker's/user's profile may be “indicated as available” to float out for that unit of work (e.g., available for reassignment). For instance, as shown in FIG. 27, a worker's/user's schedule can be accessed via the scheduling system 100 (e.g., via a user operating a worker/user computing device 110). In this example, in the worker's/user's schedule, an assigned unit of work (e.g., 8-hour 7:00 am shift on December 12th) can be selected to allow the user to be indicated as available to float out for that unit of work. In one embodiment, selecting this option can change the availability flag for the assigned time period and/or unit of work to true—making the worker/user profile visible for reassignment to other units of work during the same period of time. Even though the availability flag can be changed to true, the worker/user remains assigned to the originally assigned unit of work until/if reassigned.

In one embodiment, entire worker/user groups can be indicated as available. For example, profiles of workers/users assigned to float pools can all be indicated as available for scheduling operations for certain activities or types of units of work until assigned. In other words, certain activities can be used to set the availability flag to true by default. In various embodiments, this may eliminate the need of individually indicating each worker/user profile in the group as available.

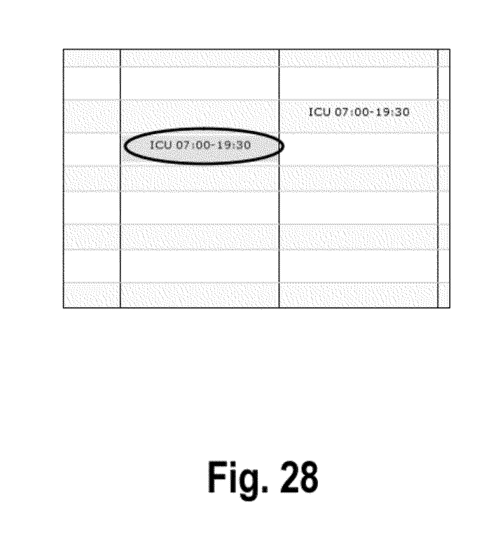

In response to (e.g., after) receiving input indicating a worker/user profile as available for a unit of work, the scheduling system 100 can provide a visual indication on the worker's/user's schedule representing the available for reassignment status. For instance, as shown in FIG. 28, the unit of work on the worker's/user's schedule can be highlighted in various colors, circled, and/or otherwise differentiated from the other units of work. The scheduling system 100 can also generate a notification that the worker/user is available for reassignment and/or make the worker/user visible in assignment operations. Such notifications can be sent to not only those who assign units of work, but also to workers/users who are now indicated as available.

ii. Exemplary Automated Worker/User Profile Identification

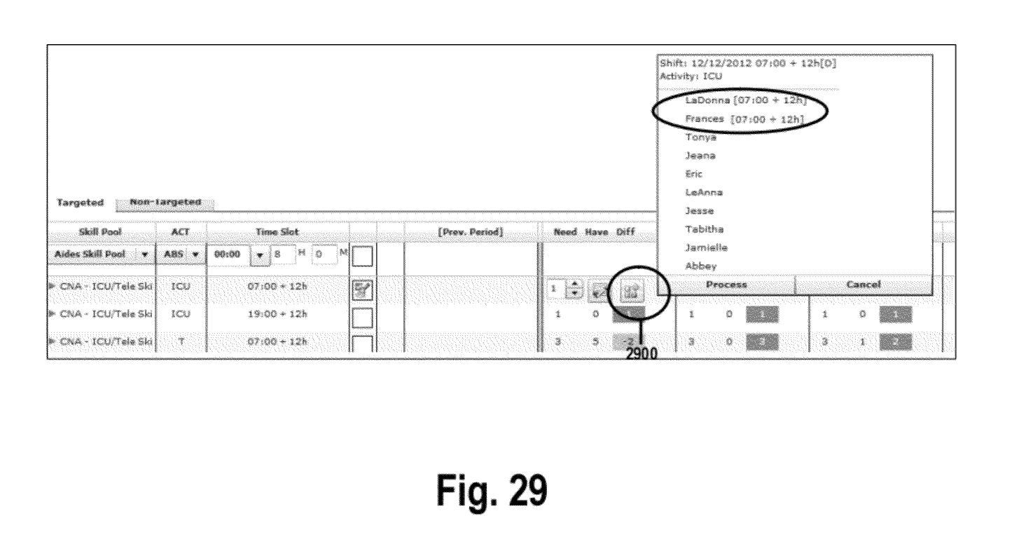

In one embodiment, as described, the scheduling system 100 can perform automated scheduling operations. For example, the scheduling system 100 can automatically identify one or more worker/user profiles that can be assigned to a unit of work. This operation may also include identifying worker/user profiles that have been indicated as available for reassignment. To do so, a worker/user may click on or select information corresponding to a unit of work to assign. For example, as shown in FIG. 29, the scheduling system can receive input (e.g., selecting icon/glyph 2900) from a worker/user requesting an automated scheduling operation (Block 505 of FIG. 5). In this example, the unit of work is for a CNA to work a 12-hour shift starting at 7:00 am on Dec. 12, 2012. In response to (e.g., after) receiving such input, the scheduling system 100 can automatically identify worker/user profiles that can be assigned to perform the unit of work—including worker/user profiles that have been indicated as available for reassignment.

In one embodiment, to perform this operation, as indicated in Block 510 of FIG. 5, the scheduling system 100 can automatically identify worker/user profiles that are qualified to be assigned to the unit of work and that comply with any corresponding rules. In this example, the worker/user must be a CNA and be able to work a 12-hour shift starting 7:00 am on Dec. 12, 2012. As will be recognized, a variety of other rules and requirements may also be considered. Accordingly, the scheduling system 100 can evaluate the worker/user profiles and eliminate (e.g., filter) any profiles of workers/users who are not CNAs and who are not available to work in this time period. For instance, a rule may require that the unit of work and any worker/user profiles that have been indicated as available for reassignment for the unit of work have “substantially similar” start times, end times, and/or the like. By way of example, to be reassignable, the end times may be required to be within 1 hour of each other. Similarly, to be reassignable, the start times may be required to be within two hours of each other. At this point, the resultant worker/user profiles are the assignable worker/user profiles and the “reassignable worker/user profiles” (e.g., the profiles indicated as available for reassignment).

In one embodiment, the scheduling system 100 can then cause display of the assignable and reassignable worker/user profiles (Block 515 of FIG. 5). For example, as shown in FIG. 29, the workers/users corresponding to the assignable worker/user profiles are Tonya, Jeana, Eric, LeAnna, Jesse, Tabitha, Jameille, and Abbey. The workers/users corresponding to the reassignable worker/user profiles are LaDonna and Frances. The worker/user profiles for LaDonna and Frances can be indicated as reassignable workers/users by including the time period of the unit of work to which they are already assigned proximate their names in the list. In various embodiments, such an indication may be helpful to the scheduler in cost effectively assigning worker/user to units of work.

In one embodiment, as indicated in Block 520 of FIG. 5, after causing display of the assignable and reassignable worker/user profiles, the scheduling system 100 can receive input assigning an assignable or reassignable worker/user profile to the unit of work (e.g., via a worker/user, operating a worker/user computing device 110). If authorization is not required to assign the assignable or reassignable worker/user profile to the unit of work, the scheduling system 100 can update the worker/user profile to reflect the assignment of the unit of work (e.g., set the worker's/user's availability flag to false for the assigned time period) and indicate that the unit of work has been assigned (Block 525 of FIG. 5). As previously discussed, by setting the worker's/user's availability flag to false for the assigned time period, the worker/user profile will not be shown as assignable to other units of work for the same time period. If authorization is required, the scheduling system 100 can automatically generate a request to authorize or deny the assignment of the worker/user profile (although such a step may be omitted). In response to (e.g., after) receiving an authorization from the appropriate party, the scheduling system 100 can update the assignable worker/user profile to reflect the assignment of the unit of work and indicate that the unit of work has been assigned (Block 525 of FIG. 5). Otherwise, the scheduling system 100 does not assign the unit of work to the worker/user profile, such as in the event of a denial of the request for authorization.

In one embodiment, when a worker/user profile is reassigned, the reassigned worker/user profile will no longer be shown as assigned to the originally assigned unit of work. Instead, the reassigned worker/user profile will be shown as assigned to the newly reassigned unit of work. In various embodiments, the history of the various assignments and reassignments can be recorded, tracked, and associated with the corresponding worker/user profiles.

iii. Exemplary Automated Unit of Work Identification

In various embodiments, the scheduling system 100 can automatically identify one or more assignable units of work for a reassignable worker/user profile (e.g., a worker/user profile indicated as available). For example, the scheduling system 100 can evaluate the units of work to which a reassignable worker/user profile can be assigned. As previously described, the scheduling system 100 can then cause display of the assignable units of work. After causing display of the assignable units of work, the scheduling system 100 can receive input reassigning the reassignable worker/user profile to a unit of work (e.g., via a worker/user operating a worker/user computing device 110). If authorization is not required to assign the reassignable worker/user profile to the unit of work, the scheduling system 100 can update the reassignable worker/user profile to reflect the assignment of the unit of work (e.g., set the worker's/user's availability flag to false for the assigned time period) and indicate that the unit of work has been assigned. As previously discussed, by setting the worker's/user's availability flag to false for the assigned time period, the worker/user profile will not be shown as assignable to other units of work for the same time period. If authorization is required, the scheduling system 100 can automatically generate a request to authorize or deny the assignment of the reassignable worker/user profile. In response to (e.g., after) receiving an authorization from the appropriate party, the scheduling system 100 can update the reassignable worker/user profile to reflect the assignment of the unit of work and indicate that the unit of work has been assigned. Otherwise, the scheduling system 100 does not assign the unit of work to the worker/user profile, such as in the event of a denial of the request for authorization.

In one embodiment, when a worker/user profile is reassigned, the reassigned worker/user profile will no longer be shown as assigned to the originally assigned unit of work. Instead, the reassigned worker/user profile will be shown as assigned to the newly reassigned unit of work. In various embodiments, the history of the various assignments and reassignments can be recorded, tracked, and associated with the corresponding worker/user profiles.

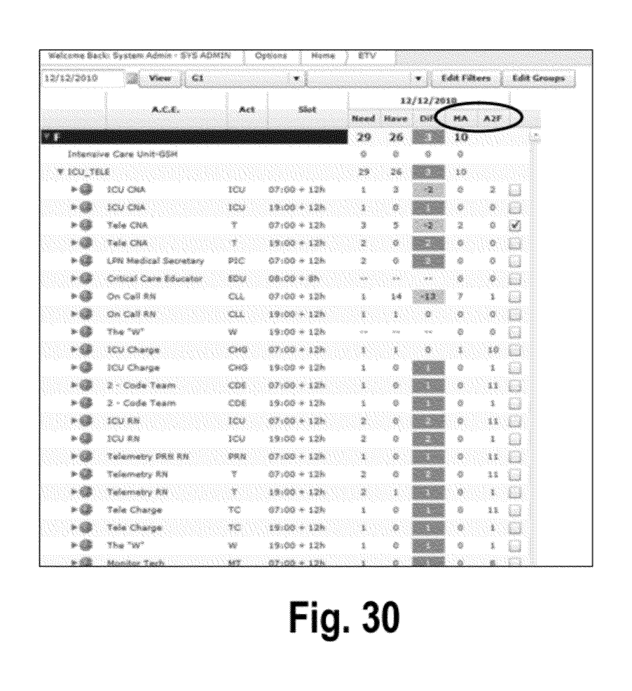

In one embodiment, as shown in FIG. 30, various dashboards can also be used to provide schedulers with a variety of information for scheduling. For instance, as shown in FIG. 30, the “MA” (e.g., (Marked as Available or Indicated as Available)) column can be used to show the number of worker/user profiles assigned to a corresponding unit of work, but who have been indicated as available to float out of that unit of work and who are qualified to float into the selected unit of work. Similarly, the “A2F” (Available to Float) column shows the number of worker/user profiles currently filling the selected unit of work who have been indicated as available and can float out of that unit of work.

IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for reassigning worker profiles to units of work, the method comprising:
electronically storing a plurality of worker profiles corresponding respectively to a plurality of workers;
electronically receiving input selecting a new unit of work of a plurality of units of work for scheduling, wherein each unit of work comprises one or more work requirements selected from the group consisting of a primary skill, a start time, and an end time; and
after receiving input selecting the new unit of work of the plurality of units of work for scheduling, automatically identifying a reassignable worker profile of the plurality of worker profiles that can be assigned to the new unit of work, wherein (a) the reassignable worker profile is assigned to a previous unit of work, (b) the reassignable worker profile has been indicated as being available for reassignment from the previous unit of work, and (c) at least (1) the start time of the new unit of work is substantially similar to the start time of the previous unit of work or (2) the end time of the new unit of work is substantially similar to the end time of the previous unit of work.

2. The method of claim 1 further comprising:
causing display of the reassignable worker profile;
electronically receiving input assigning the reassignable worker profile to the new unit of work;
after receiving input assigning the reassignable worker profile to the new unit of work, generating a request to (a) authorize or (b) deny the assignment of the reassignable worker profile to the new unit of work;
electronically receiving input authorizing the assignment of the reassignable worker profile to the new unit of work; and
electronically updating the reassignable worker profile to reflect the assignment of the new unit of work.

3. The method of claim 1 further comprising:
causing display of the reassignable worker profile;
electronically receiving input assigning the reassignable worker profile to the new unit of work; and
after receiving input assigning the reassignable worker profile to the new unit of work, electronically updating the reassignable worker profile to reflect the assignment of the new unit of work.

4. The method of claim 3, wherein automatically identifying the reassignable worker profile that can be assigned to the new unit of work further comprises electronically identifying at least one worker group associated with the reassignable worker profile.

5. The method of claim 3, wherein the reassignable worker profile comprises one or more attributes selected from the group consisting of a primary skill, a base rate of pay, and languages spoken.

6. The method of claim 1 further comprising electronically receiving input defining the plurality of units of work.

7. A computer program product for reassigning worker profiles to units of work, the computer program product comprising at least one computer-readable storage medium having computer-readable program code portions stored therein, the computer-readable program code portions comprising:
an executable portion configured to store a plurality of worker profiles corresponding respectively to a plurality of workers;
an executable portion configured to receive input selecting a new unit of work of a plurality of units of work for scheduling, wherein each unit of work comprises one or more work requirements selected from the group consisting of a primary skill, a start time, and an end time; and
an executable portion configured to, after receiving input selecting the new unit of work of the plurality of units of work for scheduling, automatically identify a reassignable worker profile of the plurality of worker profiles that can be assigned to the new unit of work, wherein (a) the reassignable worker profile is assigned to a previous unit of work, (b) the reassignable worker profile has been indicated as being available for reassignment from the previous unit of work, and (c) at least (1) the start time of the new unit of work is substantially similar to the start time of the previous unit of work or (2) the end time of the new unit of work is substantially similar to the end time of the previous unit of work.

8. The computer program product of claim 7 further comprising:
an executable portion configured to cause display of the reassignable worker profile;
an executable portion configured to receive input assigning the reassignable worker profile to the new unit of work;
an executable portion configured to, after receiving input assigning the reassignable worker profile to the new unit of work, generate a request to (a) authorize or (b) deny the assignment of the reassignable worker profile to the new unit of work;
an executable portion configured to receive input authorizing the assignment of the reassignable worker profile to the new unit of work; and
an executable portion configured to update the reassignable worker profile to reflect the assignment of the new unit of work.

9. The computer program product of claim 7 further comprising:
an executable portion configured to cause display of the reassignable worker profile;
an executable portion configured to receive input assigning the reassignable worker profile to the new unit of work; and
an executable portion configured to, after receiving input assigning the reassignable worker profile to the new unit of work, update the reassignable worker profile to reflect the assignment of the new unit of work.

10. The computer program product of claim 9, wherein automatically identifying the reassignable worker profile that can be assigned to the new unit of work further comprises electronically identifying at least one worker group associated with the reassignable worker profile.

11. The computer program product of claim 9, wherein the reassignable worker profile comprises one or more attributes selected from the group consisting of a primary skill, a base rate of pay, and languages spoken.

12. The computer program product of claim 7 further comprising electronically receiving input defining the plurality of units of work.

13. An apparatus comprising at least one processor and at least one memory including computer program code, the at least one memory and the computer program code configured to, with the processor, cause the apparatus to at least:
store a plurality of worker profiles corresponding respectively to a plurality of workers;
receive input selecting a new unit of work of a plurality of units of work for scheduling, wherein each unit of work comprises one or more work requirements selected from the group consisting of a primary skill, a start time, and an end time; and
after receiving input selecting the new unit of work of the plurality of units of work for scheduling, automatically identify a reassignable worker profile of the plurality of worker profiles that can be assigned to the new unit of work, wherein (a) the reassignable worker profile is assigned to a previous unit of work, (b) the reassignable worker profile has been indicated as being available for reassignment from the previous unit of work, and (c) at least (1) the start time of the new unit of work is substantially similar to the start time of the previous unit of work or (2) the end time of the new unit of work is substantially similar to the end time of the previous unit of work.

14. The apparatus of claim 13, wherein the memory and computer program code are further configured to, with the processor, cause the apparatus to:
cause display of the reassignable worker profile;
receive input assigning the reassignable worker profile to the new unit of work;
after receiving input assigning the reassignable worker profile to the new unit of work, generate a request to (a) authorize or (b) deny the assignment of the reassignable worker profile to the new unit of work;
receive input authorizing the assignment of the reassignable worker profile to the new unit of work; and
update the reassignable worker profile to reflect the assignment of the new unit of work.

15. The apparatus of claim 13, wherein the memory and computer program code are further configured to, with the processor, cause the apparatus to:
cause display of the reassignable worker profile;
receive input assigning the reassignable worker profile to the new unit of work; and
after receiving input assigning the reassignable worker profile to the new unit of work, update the reassignable worker profile to reflect the assignment of the new unit of work.

16. The apparatus of claim 15, wherein automatically identifying the reassignable worker profile that can be assigned to the new unit of work further comprises electronically identifying at least one worker group associated with the reassignable worker profile.

17. The apparatus of claim 15, wherein the reassignable worker profile comprises one or more attributes selected from the group consisting of a primary skill, a base rate of pay, and languages spoken.

18. The apparatus of claim 13 further comprising electronically receiving input defining the plurality of units of work.
